(19) United States
(12) Patent Application Publication
(10) Pub. No.: US 2018/0130443 A1
(43) Pub. Date: May 10, 2018

(54) TECHNIQUES FOR MANAGING TRANSMISSION AND DISPLAY OF A DISPLAY DATA STREAM

(71) Applicants: NAUSHEEN ANSARI, FOLSOM, CA (US); KARTHI R. VADIVELU, FOLSOM, CA (US); PAUL S. DIEFENBAUGH, PORTLAND, OR (US)

(72) Inventors: NAUSHEEN ANSARI, FOLSOM, CA (US); KARTHI R. VADIVELU, FOLSOM, CA (US); PAUL S. DIEFENBAUGH, PORTLAND, OR (US)

(21) Appl. No.: 15/344,257

(22) Filed: Nov. 4, 2016

(51) Int. Cl. G09G 5/00; G09G 5/395

(52) U.S. Cl. CPC G09G 5/006; G09G 5/395; G09G 2360/127; G09G 2370/10; G09G 2310/08; G09G 2360/18

(57) ABSTRACT

Computing devices and techniques for managing transmission and display of a display data stream are described. In one embodiment, for example, an apparatus may include at least one memory and logic for a display source, at least a portion of the logic comprised in hardware coupled to the at least one memory, the logic to generate display information comprising at least one frame for presentation at a display panel operably coupled to a display sink, receive display sink information indicating a space availability of a buffer of the display sink, the buffer to store at least a portion of the display information, and provide the display information to the display sink based on the display sink information. Other embodiments are described and claimed.

### TECHNICAL FIELD

Embodiments herein generally relate to information processing, and more particularly, to transmission of display information from a display source to a display sink for presentation on a display panel.

### BACKGROUND

Computing devices and consumer electronic products often include a display device for presenting images on a display screen or panel. A display device may include a display sink operative to receive display information from a display source for updating the image presented on the display panel. The display information may be provided in the form of display frames transmitted according to a predefined rate. A display frame may include an image to be presented on the display screen.

Conventional display devices include a dedicated channel for receiving the display information. Illustrative dedicated channels may include a high-definition multimedia interface (HDMI) dedicated link from the display source to the display sink and/or a DisplayPort interface configured to support one or more data streams over a single cable, with each stream having a dedicated time-multiplexed slot. A display source may manage transmission of source information to a display sink using the predefined rate of transmission and the direct link provided by a dedicated channel.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a fourth operating environment.

FIG. 5 illustrates an embodiment of a fifth operating environment.

FIG. 6 illustrates an embodiment of a sixth operating environment.

FIG. 7 illustrates an embodiment of a first logic flow.

FIG. 8 illustrates an embodiment of a second logic flow.

FIG. 9 depicts an illustrative device according to an embodiment.

FIG. 10 depicts an illustrative device according to an embodiment.

### DETAILED DESCRIPTION

Various embodiments may be generally directed to techniques for managing transmission of display information from a display source to a display sink. The display information may be presented via a display panel of a display device including or in operable communication with the display sink. In various embodiments, the display source may be decoupled from display timings associated with the display sink such that the display source may transmit display information asynchronous with one or more of the display timings. Non-limiting examples of display timings may include a display refresh rate, blanking times, active pixel times, and/or the like. In some embodiments, the display sink may include a display information buffer (or “frame buffer”) operative to buffer display information received from a display source. In various embodiments, a display sink may transmit display information based on availability of space in one or more display information buffers instead of, for example, transmitting display information based on when the display sink requires display information. The display sink may then operate, drive, control, or otherwise manage the display panel using the display information based on locally generated display timings. In some embodiments, the display source may receive buffer information associated with one or more display information buffers of the display sink. Buffer information may indicate available space information, including, without limitation, whether the one or more display information buffers have availability, an amount of available space in the one or more display information buffers (for example, a number of available bytes, a number of frames that can be stored, and/or the like), a threshold availability indicator, and/or the like.

Display technology is transitioning to a shared transport mechanism, a converged physical layer (for instance, PHY layer), and use of a single connector. In addition, improved data compression and power management techniques allow display sinks to include more buffering capabilities. However, if a display source and a display sink interface via a generic interface (for instance, a non-dedicated channel) the display source and the display timings are required to be decoupled. For instance, the display source may transmit display information asynchronous with a display refresh rate. Accordingly, some embodiments provide techniques and apparatus in which a display source may transmit display information to a display sink without explicitly providing or otherwise driving any timing information (with certain exceptions, such as, for example, frame start times), for instance, embedded in the display data stream of display information. Such techniques may allow a display sink to more effectively and efficiently display frames at a desired time and may facilitate improved link efficiency and power management. For instance, when a display sink has a full display information buffer (or more), the display source may implement a partial frame update and/or a panel self-refresh mechanism in which, for example, only the pixels which have changed from a previous frame are transmitted.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

In one embodiment, for example, an apparatus may include at least one memory and logic for a display source, at least a portion of the logic comprised in hardware coupled to the at least one memory, the logic to generate display information comprising at least one frame for presentation at a display panel operably coupled to a display sink, receive display sink information indicating a space availability of a buffer of the display sink, the buffer to store at least a portion of the display information, and provide the display information to the display sink based on the display sink information.

In another embodiment, for example, an apparatus may include at least one memory and logic for a display sink, at least a portion of the logic comprised in hardware coupled to the at least one memory, the logic to determine display sink information indicating a space availability of at least one buffer, provide the display sink information to a display source, receive display information from the display source, and store the display information in the at least one buffer.

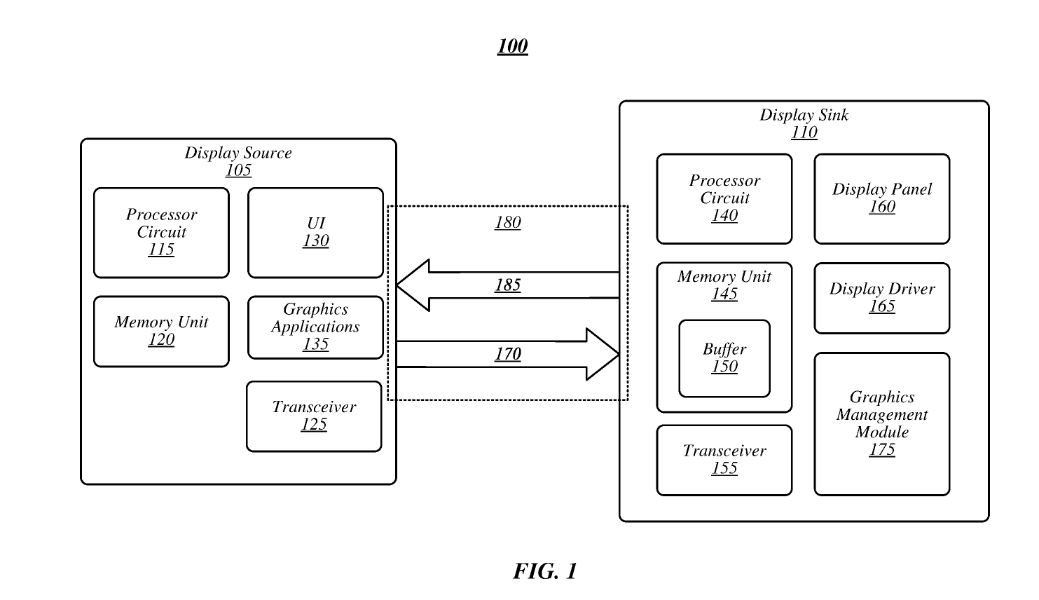

FIG. 1 illustrates an example of an operating environment 100 that may be representative of various embodiments. The operating environment 100 depicted in FIG. 1 may include a display source 105 having a processor circuit 115, a memory unit 120, and a transceiver 125. Display source 105 may be any device operable to encode and transmit graphics objects, for instance, as display information 170. In various embodiments, display source 105 may include a graphics processing unit (GPU). In some embodiments, processor circuit 115 of display source 105 may execute an operating system (OS). The OS may be operable to implement user interface (UI) 130 for receiving user input and one or more graphics applications 135 for generating graphics objects. In various embodiments, graphics applications 135 may include various graphics stacks, graphics pipeline modules, and/or the like for rendering graphics objects into graphics frames. The graphics frames may be transmitted via transceiver 125 as display information 170. In some embodiments, display information 170 may be transmitted as a data stream, including, without limitation, a video stream, an audio stream, an audio/video stream, and/or the like.

The operating environment 100 may include a display sink 110 having a processor circuit, a memory unit 145, and a transceiver 155. In some embodiments, transceiver 155 and/or transceiver 125 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating via such networks, transceiver 155 and/or transceiver 125 may operate in accordance with one or more applicable standards in any version. The embodiments are not limited in this context.

Display sink 110 may be communicatively coupled to display source 105 via a link 180 through one or more wired or wireless connections. In some embodiments, display sink 110 and display source 105 may be incorporated within a same electronic device. Non-limiting examples of electronic devices may include, without limitation, a wearable computing device, a laptop computer, a tablet computing device, a handheld computer, a cellular telephone, a smart device (for instance, a smart phone, a smart tablet, or a smart television), a large format television (for instance, a high-definition (HD) television), a set-top box, a desktop computer, a home or commercial network device, and/or combinations thereof. In some embodiments, display sink 110 and display source 105 may be incorporated within separate electronic devices. In some embodiments, display source 105 may be communicatively coupled to a plurality of display sinks 110. In some embodiments, display sink 110 may be communicatively coupled to a plurality of display sources 105.

As shown in FIG. 1, display sink 110 may include a buffer 150 operable to store display information 170. In some embodiments, display sink 110 may include a plurality of buffers 150. Non-limiting examples of buffers 150 may include a data buffer, a frame buffer, an assembly frame buffer, a display frame buffer, and/or the like. Buffer 150 may be implemented using various buffer structures, techniques, and/or the like. In some embodiments, the buffer 150 may include a circular buffer. In some embodiments, buffer 150 may include a circular buffer in which display information 170 received at display sink 110 is placed into buffer 150 sequentially. In some embodiments, buffer 150 may have a buffer size, for example, including a buffer minimum size. In some embodiments, the minimum buffer size may depend on the capabilities and/or attributes of the transport layer between display source 105 and display sink 110 and/or latency through a topology on the transmission and return channel.

In various embodiments, display sink 110 may include a display panel 160 operable to present visual images. Display panel 160 may include various types of displays capable of displaying a visual interface to a user, including, without limitation, light emitting diode (LED), organic LED (OLED), cathode ray tube (CRT), liquid crystal display (LCD), plasma, electroluminescence (EL), and/or the like. Display source 105 may transmit frames for the visual images in display information 170 to display sink 110. A display driver 165, or other graphics application, operating on display sink 110 may use the frames to update the visual image presented on display panel 160. Display driver 165 may control display timings for displaying images on the display panel. For example, display timings may include blanking times, active pixel times, and/or refresh rate. The refresh rate may be a function of the horizontal total and the vertical total. The horizontal/vertical active pixel times and horizontal blanking times may be static for a given resolution and, for example, may be controlled by a pixel clock of the display sink. The vertical blanking time may be variable depending on the occurrence of flip events in the source.

A graphics management module 175 may be operable on display sink 110 to implement various functions of some embodiments. In some embodiments, graphics management module 175 may operate to control the flow of data, display information 170, frames, and/or the like from display source 110. In some embodiments, graphics management module 175 may determine buffer information associated with buffer 150. In various embodiments, graphics management module 175 may implement a credit management process. In some embodiments, graphics management module 175 may transmit display sink information 185 to display source 105. Display sink information 185 may include information associated with the operation of the display sink for receiving and/or managing display information and/or buffer information. For example, display sink information 185 may indicate available space in a frame buffer of buffer 150. Display sink 105 may use the display sink information 185 for determining when to transmit display information 170 to display source 110. In some embodiments, display source 105 and/or display sink 110 may implement a discovery and/or configuration process for establishing link 180 and/or for performing various display functions. For example, during a discovery process and/or configuration process, graphics management module 175 of display sink 110 may declare a size of the buffer 150 and/or other relevant information to display source 105.

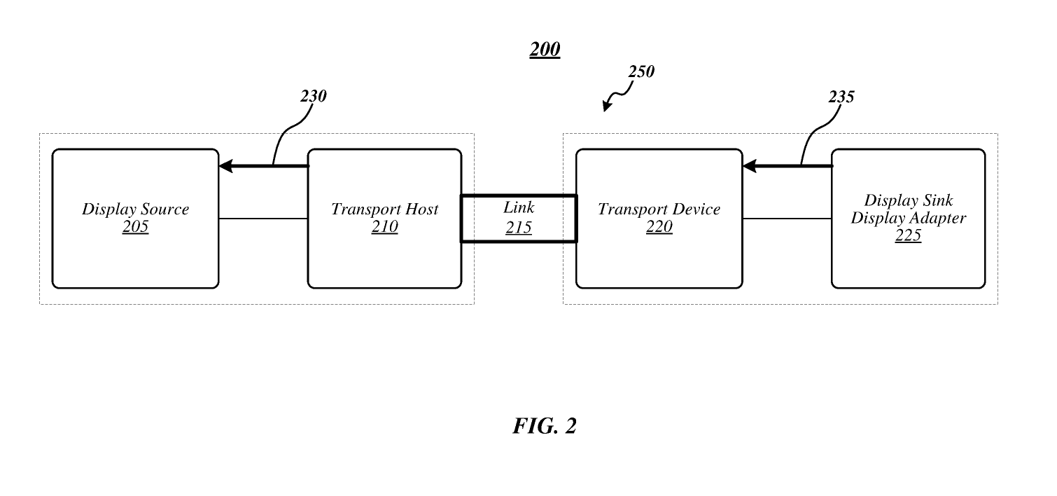

FIG. 2 illustrates an example of an operating environment 200 that may be representative of various embodiments. The operating environment 200 depicted in FIG. 2 may include a transport layer 250 for a display source 205 to provide display information, a display stream, frames to a display sink display adapter 225. In some embodiments, the transport layer 250 may include a transport layer according to transmission control protocol (TCP)/Internet protocol (IP), user datagram protocol (UDP)/IP, and/or the like. However, embodiments are not limited to TCP/IP and/or UDP/IP transport layers, as any transport layer capable of operating according to some embodiments is contemplated herein. As shown in FIG. 2, a link 215 may be established between a transport host 210 and a transport device 220. The transport layer 250 may operate to transport display information from display source 205 to display sink display adapter 225 via link 215.

In some embodiments, transport layer 250 may use a dedicated virtual channel for the display stream of display source 205 or the entire transport layer 250 may be dedicated to the display stream of display source 205. Accordingly, transport layer 250 may be used to control the flow of information from display source 205 into display information buffer associated with display sink display adapter 225. In some embodiments, display information flow control may be implemented using credit management. In some embodiments, transport layer 250 may operate a credit management process to apply flow control back pressure to control the flow of information into buffers of display sink display adapter 225. For example, display sink display adapter 225 may provide back pressure information 235 to transport device 220 to manage flow control. In another example, transport host 210 may provide back pressure information 230 to display source 205 to manage flow control. In some embodiments, back pressure 230 and 235 may be provided based on credits and/or the availability of space in one or more frame buffers associated with display sink display adapter 225. In some embodiments, display sink information 185 may include back pressure information 230 and/or 235. In some embodiments, back pressure information 230 and/or 235 may include data, control signals, and/or the like indicating that display source 205 should not transmit display information and/or transmit display information at a slower rate.

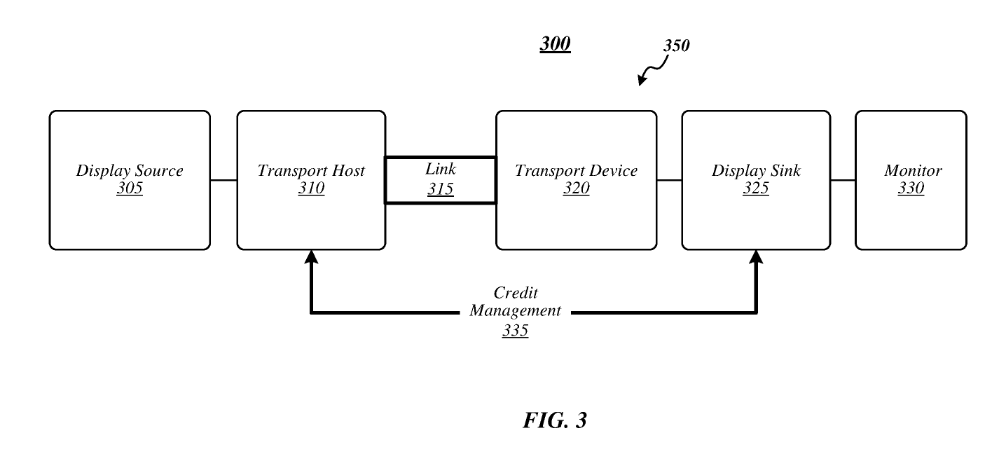

FIG. 3 illustrates an example of an operating environment 300 that may be representative of various embodiments. The operating environment 300 depicted in FIG. 3 may include a transport layer 350 for a display source 305 to provide display information, such as a display stream, to a display sink 325 for presentation on a monitor 330. Display source 305 may be communicatively coupled to display sink 325 via a link 315 through a transport host 310 and a transport device 320. In the embodiment depicted in FIG. 3, transport layer 350 does not include a dedicated virtual channel for a display stream of a display source 305 nor a credit management process. Accordingly, display sink 325 operates a credit management process 335 for reporting back buffer information, such as space availability, to display source 305. For example, display sink 325 may operate a credit management 335 process to communicate back pressure information, buffer information, control signals, and/or the like to transport host 310. In some embodiments, space availability may be indicated using periodic updates through credit management process 335 generated based on a threshold amount of time and/or after certain display events. In some embodiments, the granularity of the buffer information provided via credit management process 335 may be in bytes, frames, and/or the like.

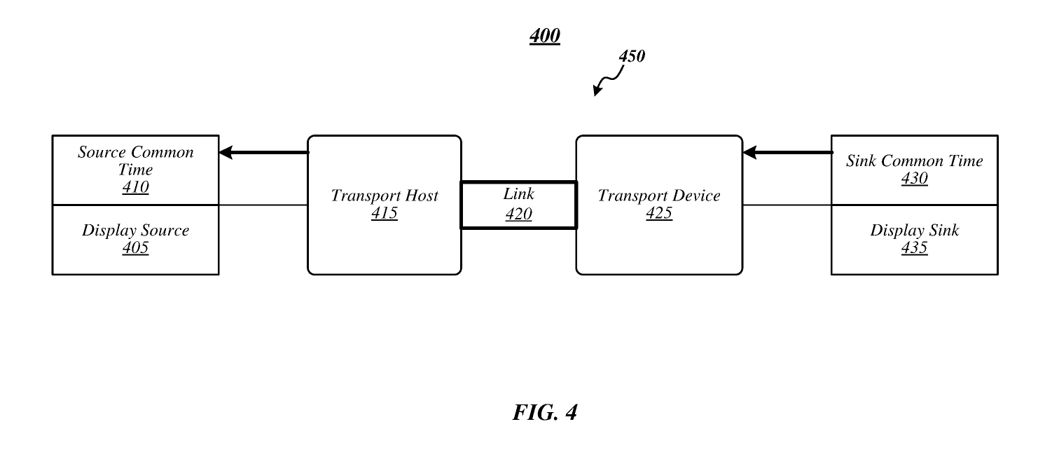

FIG. 4 illustrates an example of an operating environment 400 that may be representative of various embodiments. The operating environment 400 depicted in FIG. 4 may include a transport layer 450 for a display source 405 to transmit display information, such as a display stream, to a display sink 435 through a link 420 implemented between a transport host 415 and a transport device 425.

In some embodiments, the display information may be formed of or may include data packets (or “packets”). In various embodiments, the data packets may include an identifier and data corresponding to a block of pixels. In some embodiments, the identifier may include a frame number the pixel block belongs to and other information, such as position coordinates, block size, and/or the like. The contiguous block of pixel data may be placed in a display information buffer at the display sink 435. In some embodiments, multiple data packets may be required to transfer an entire frame.

A frame-start control packet may be provided by display source 405 for use by display sink 435 to determine when a frame should be presented on a display panel. For example, a frame-start control packet may include frame presentation information that includes a frame number and a presentation time stamp indicating a time that the frame associated with the frame number should be presented. The presentation time stamp may be formed in various time units, such as absolute time (for instance, absolute common-time units, such as hour:minute:seconds:milliseconds, and/or the like). In some embodiments, the presentation time stamp of the frame-start control packet may be used by display sink 435 to adjust a pixel clock, for example, to minimize drift and/or to prevent underruns. In some embodiments, the frame-start control packet may be issued by display source 405 with every frame.

In some embodiments, transport layer 450 may implement an absolute frame-start mode to facilitate the presentation of frames at the correct time. In absolute frame-start mode, transport layer 450 may maintain a common time-base between display source 405 and display sink 435 to ensure that each frame is presented at the correct time. In some embodiments, a common time may be established between display source 405 and display sink 435 to synchronize a source common time 410 and a sink common time 430. In absolute frame-start mode, display sink 435 may start a frame when sink common time 430 matches a common time value in the frame-start control packet that corresponds to a buffer of the display sink 435, such as a display frame buffer.

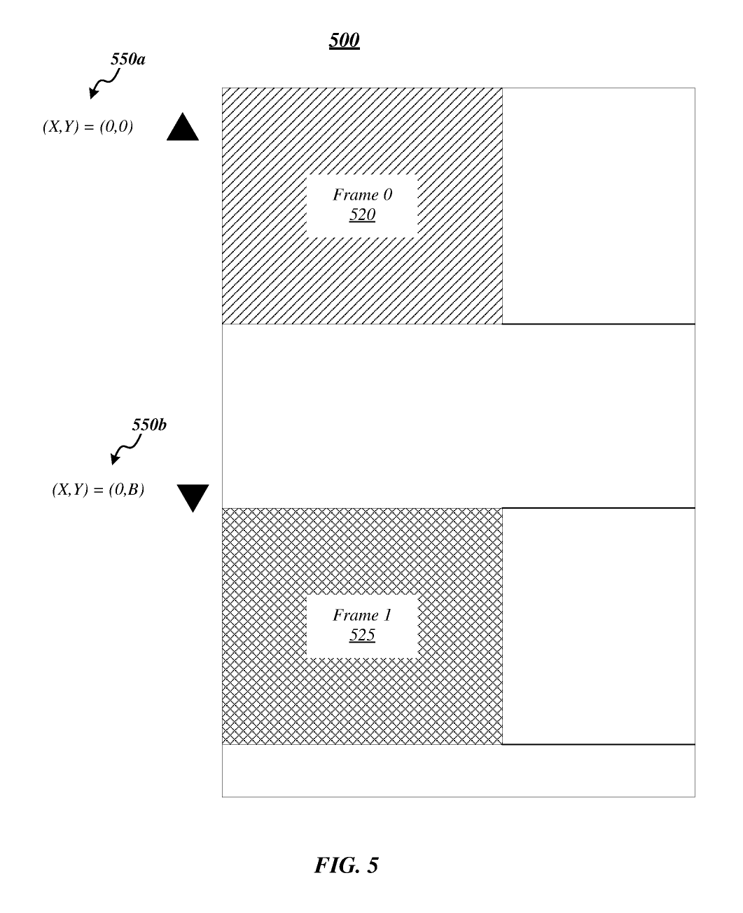

FIG. 5 illustrates an example of an operating environment 500 that may be representative of various embodiments. The operating environment 500 depicted in FIG. 5 may include a relative frame-start mode operative if a transport layer does not have a common time-base process for implementing an absolute frame-start mode (for example, as depicted in FIG. 4). In relative frame-start mode, a frame-start control packet may specify a relative time delay to indicate a presentation time stamp (for instance, a time to present the corresponding frame). Accordingly, in various embodiments, the presentation information may include a relative time for presentation of a frame relative to a previously presented frame. In some embodiments, the relative time delay may include a pixel location relative to the beginning of a previous frame.

As shown in FIG. 5, the time to display a current frame 520, 525 may be specified in terms of coordinates 550a, 550b (for instance, “X, Y” coordinates). In some embodiments, the “X” portion of the coordinates may always be zero. In relative frame-start mode, a display sink may wait until a pixel counter for a display frame buffer reaches the location specified in the frame-start control packet corresponding to a buffer of the display sink, such as an assembly frame buffer. At this point, the pixel counter may be reset and the flip to an assembly buffer may occur and frame display may be initiated at a display panel.

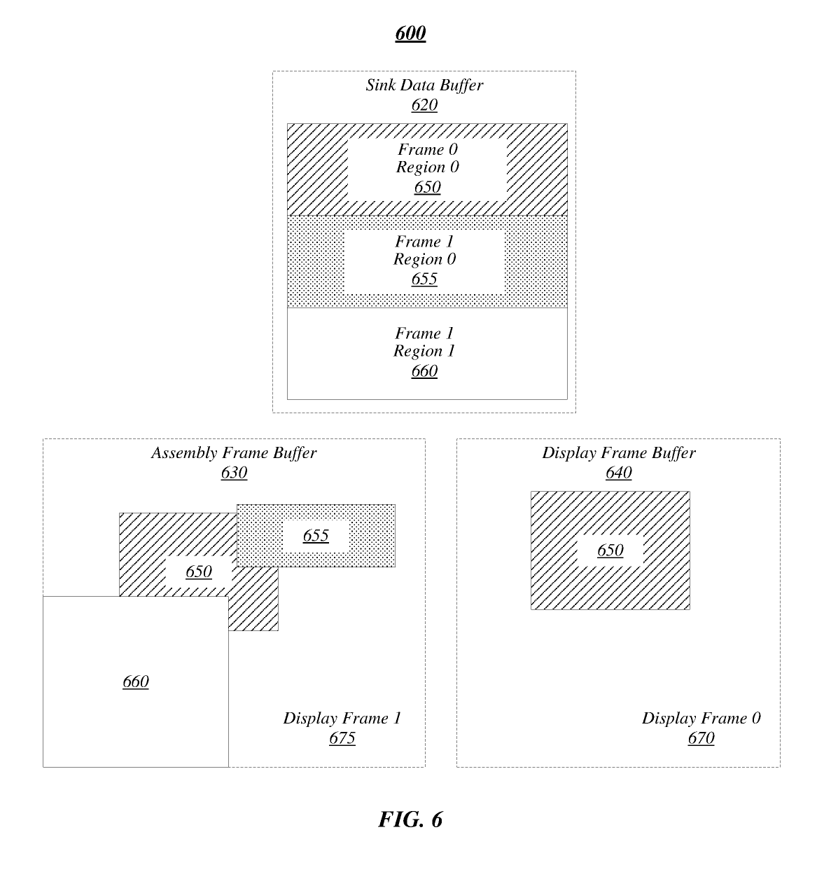

FIG. 6 illustrates an example of an operating environment 600 that may be representative of various embodiments. The operating environment 600 depicted in FIG. 6 includes buffers used by a display sink according to some embodiments. More specifically, FIG. 6 depicts a sink data buffer 620, an assembly frame buffer 630, and a display frame buffer 640. In some embodiments, the data and control packets transmitted by a display source to a display sink may be placed in and consumed from sink data buffer 620. As shown in FIG. 6, sink data buffer 620 may store various frames and/or portions thereof (for instance, regions of frames), such as frame 0, region 0 650, frame 1, region 0 655, frame 1, region 1 660.

In various embodiments, if sink data buffer 620 has less than a frame buffer worth of storage, the display sink must ensure that data for every frame is transmitted at or higher than the required refresh rate of the display panel. In various embodiments, with an entire display frame buffer 640 behind the sink data buffer 620 in the display sink, the display source may send display information (for example, frame data) and the frame-start control packet only when a display frame is updated. For instance, the display sink may have two full frame buffers, such as a front (display) buffer that the display sink (such as a time controller of the display sink) may read from to draw pixels on a display panel and a back buffer (for example, a display buffer) that is collecting and/or integrating pixels to be displayed on the next frame. In some embodiments, when a frame-start control packet is not available in sink data buffer 620, the display sink may proceed with replaying a frame from the display frame buffer 640 at the refresh rate. In various embodiments, with two frame buffers behind sink data buffer 620, instead of transferring an entire frame, display source may issue selective updates to only sections of an image presented on a display panel (for instance, rectangular sections of the display panel screen, a frame, and/or the like).

In some embodiments, the display sink may display frames out of display frame buffer 640. As shown in FIG. 6, the display sink may present display frame 0 670 out of display frame buffer 640. In various embodiments, assembly frame buffer 6340 may be used by the display sink to build and generate a subsequent frame, for instance, display frame 1 675 that may be displayed after display frame 0 670. In some embodiments, when only one or more portions of a frame buffer 620, 630, and/or 640 is updated, the updated regions may be read from sink data buffer 620 during assembly into assembly frame buffer 630. The remaining unchanged regions may be copied from display frame buffer 640 to assembly frame buffer 630 during assembly. Once the entire frame buffer is created in the assembly frame buffer (for instance, frame buffer for display frame 1), the frame is ready for display and the display sink will flip to assembly frame buffer 630 (for instance, assembly frame buffer 630 will become display frame buffer 640, and vice versa).

Included herein is a set of logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on a non-transitory computer readable medium or machine readable medium, such as an optical, magnetic or semiconductor storage. The embodiments are not limited in this context.

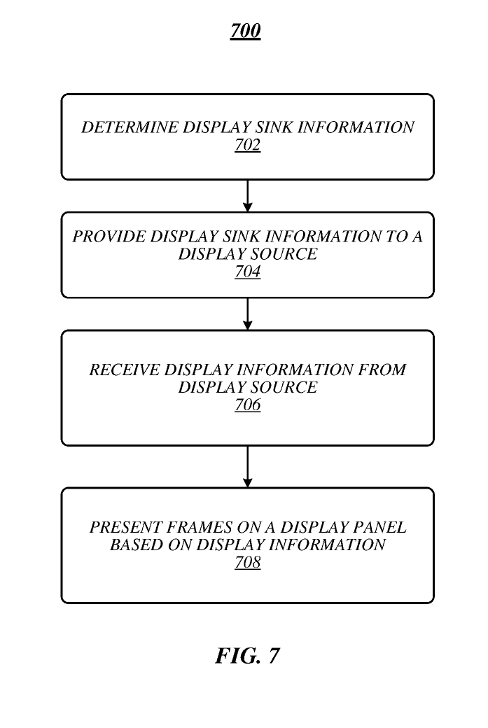

FIG. 7 illustrates an embodiment of a logic flow 700. The logic flow 700 may be representative of some or all of the operations executed by one or more embodiments described herein, such as display sink 110, display sink display adapter 225, display sink 325, and/or display sink 435.

In the illustrated embodiment shown in FIG. 7, the logic flow 700 at block 702 may determine display sink information. For example, graphics management module 175 of display sink 110 may determine display sink information that includes space availability in a buffer 150 configured to store display information 170. A non-limiting example of a buffer 150 may include sink data buffer 620.

At block 704, display sink information may be provided to a display source. For instance, display sink 110 may transmit display sink information 185 to display source 105 over a link 180 operative to communicatively couple display sink 110 and display source. In some embodiments, link 180 may be formed by or may include a transport layer, such as transport layer 250, 350, or 450. In some embodiments, the display sink information may include credit management information provided as part of a credit management process. Display information may be received from display source at block 706. For example, display source 105 may transmit display information 170 to display sink 110 based on the display sink information 185. In some embodiments, display source 105 may display information 170 in the form of transmit frames and/or portions of frames for display at a display panel 160. In various embodiments, display source 105 may transmit display information 170 based on display sink information 185. For instance, display source 105 may transmit frames based on an availability of space in a buffer 150 configured to store the frames. In another instance, display source 105 may send display information (for example, frame data) and the frame-start control packet only when a display frame is updated.

Frames may be presented on a display panel based on display information at block 708. For example, the display information may include frames and a frame-start control packet. The frame-start control packet may be used by display sink 435 to determine when a frame should be presented on a display panel. For example, a frame-start control packet may include frame presentation information that includes a frame number and a presentation time stamp indicating a time that the frame associated with the frame number should be presented. The display sink 435 may implement an absolute frame-start mode or a relative frame-start mode to facilitate presentation of frames at the correct time based on the presentation information of the frame-start control packet.

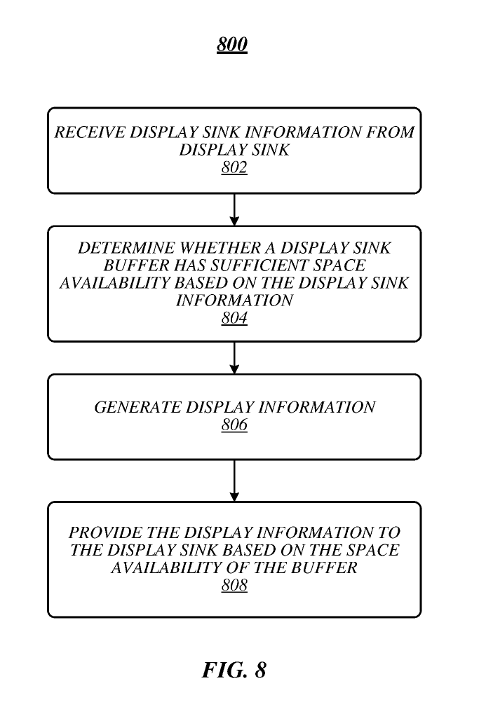

FIG. 8 illustrates an embodiment of a logic flow 800. The logic flow 800 may be representative of some or all of the operations executed by one or more embodiments described herein, such as display source 105, display source 205, display source 305, and/or display source 405.

In the illustrated embodiment shown in FIG. 8, the logic flow 800 at block 802 may receive display sink information from a display sink, such as display sink 110, display sink display adapter 225, display sink 325, and/or display sink 435. For example, display sink 110 may transmit display sink information 185 to display source 105. In some embodiments, display sink information 185 may indicate space availability of buffer 150.

At block 804, whether a display sink buffer has sufficient space availability may be determined based on the display sink information. For example, sufficient space availability may include whether a display sink buffer 150, such as sink data buffer 620, configured to store display information may store a display information transmission, such as a packet, frame, or other structure of transmitted information. In some embodiments, sufficient space availability may be space available to store a frame. In some embodiments, sufficient space availability may be space available to store information included in a packet, which may include a portion of a frame. In some embodiments, sufficient space availability may be space available to store a frame, a portion of a frame, a packet that includes a frame or a portion of a frame, and/or a frame-start control packet.

Display information may be generated at block 806. For instance, display source 105 may generate frames for presentation as an image on display panel 160. In some embodiments, the display information may include a packet configured to be used by display source 105 to transmit a frame, a portion of a frame, and/or time-start control information to display sink 110. In some embodiments, display source 105 may only generate frames and/or portions of frames (for instance, a frame region) only for portions of a presented image that is changed from a first frame to a subsequent frame. In some embodiments, non-changed portions of the frame (for instance, the portion of a second frame to be displayed that are the same as a corresponding portion of a first frame currently being displayed) may be obtained by display sink 110 from a buffer storing at least a portion of non-changed portions of the frame.

At block 808, the display information may be provided to the display sink based on the space availability of the buffer. For example, display source 105 may generate display information 170 that includes a plurality of packets for display sink 110 to generate a frame for presentation via display panel 160 and a start-frame control packet for the frame. Display source 105 may transmit the display information 170 responsive to display sink information 165 indicating sufficient available space in buffer 150 to store one or more of the plurality of packets. In some embodiments, display source 105 may transmit the display information responsive to the space availability indicating sufficient space for all of the frame packets. In some embodiments, display source 105 may transmit the display information responsive to the space availability indicating sufficient space for at least one of the frame packets.

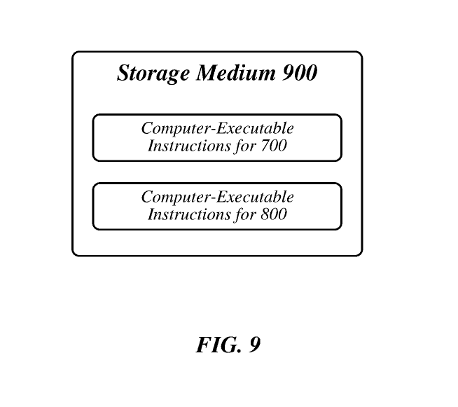

FIG. 9 illustrates an embodiment of a storage medium 900. Storage medium 900 may comprise any non-transitory computer-readable storage medium or machine-readable storage medium, such as an optical, magnetic or semiconductor storage medium. In various embodiments, storage medium 900 may comprise an article of manufacture. In some embodiments, storage medium 900 may store computer-executable instructions, such as computer-executable instructions to implement logic flow 700 of FIG. 7 and/or logic flow 800 of FIG. 8. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

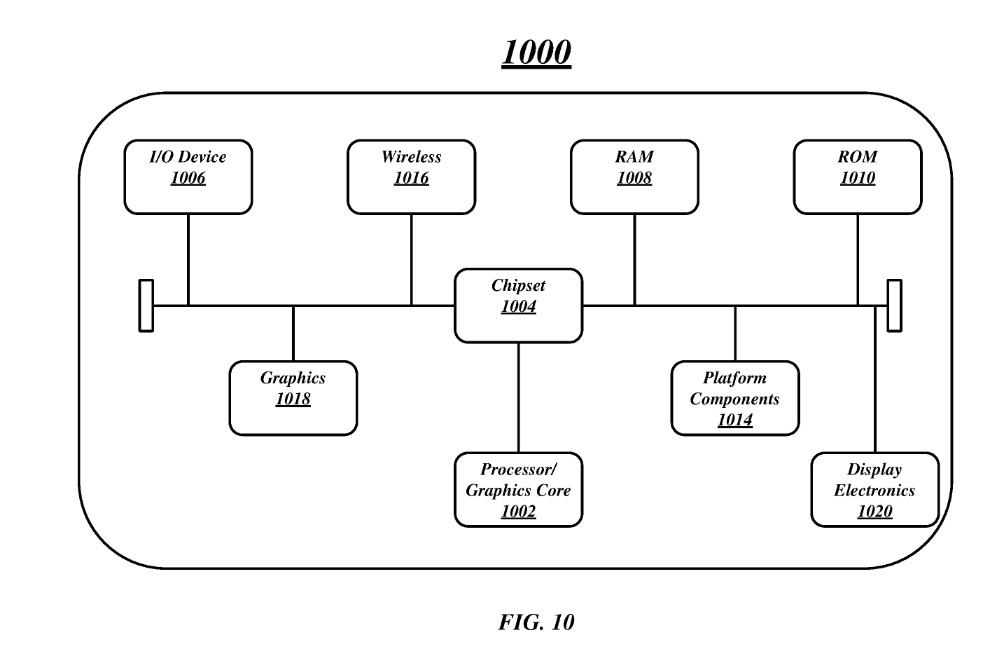

FIG. 10 depicts an illustrative device according to an embodiment. More specifically, FIG. 10 is a diagram of an exemplary system embodiment and in particular, depicts a platform 1000, which may include various elements. For instance, this figure depicts that platform (system) 1000 may include a processor/graphics core 1002, a chipset (chipset) 1004, an input/output (I/O) device 1006, a random access memory (RAM) (such as dynamic RAM (DRAM)) 1008, and a read only memory (ROM) 1010, display electronics 1020, and various other platform components 1014 (e.g., a fan, a cross flow blower, a heat sink, DTM system, cooling system, housing, vents, and/or the like). System 1000 may also include wireless communications chip 1016 and graphics device 1018. The embodiments, however, are not limited to these elements.

As depicted, I/O device 1006, RAM 1008, and ROM 1010 are coupled to processor 1002 by way of chipset 1004. Chipset 1004 may be coupled to processor 1002 by a bus 1012. Accordingly, bus 1012 may include multiple lines.

Processor 1002 may be a central processing unit comprising one or more processor cores and may include any number of processors having any number of processor cores. The processor 1002 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 1002 may be multiple separate processors located on separate integrated circuit chips. In some embodiments processor 1002 may be a processor having integrated graphics, while in other embodiments processor 1002 may be a graphics core or cores.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Example 1 is an apparatus, comprising at least one memory and logic for a display source, at least a portion of the logic comprised in hardware coupled to the at least one memory, the logic to generate display information comprising at least one frame for presentation at a display panel operably coupled to a display sink, receive display sink information indicating a space availability of a buffer of the display sink, the buffer to store at least a portion of the display information, and provide the display information to the display sink based on the display sink information.

Example 2 is the apparatus of Example 1, comprising at least on transceiver.

Example 3 is the apparatus of Example 1, comprising at least on transceiver, the logic to transmit the display information to the display sink via the at least one transceiver.

Example 4 is the apparatus of Example 1, the logic to provide the display information to a plurality of display sinks.

Example 5 is the apparatus of Example 1, the apparatus comprising at least one graphics processing unit.

Example 6 is the apparatus of Example 1, the display information comprising at least one packet, the at least one packet comprising data corresponding to a block of pixels for the at least one frame.

Example 7 is the apparatus of Example 1, the at least one packet comprising an identifier indicating a frame number a pixel block of the at least one packet belongs to.

Example 8 is the apparatus of Example 1, the logic to provide the display information via a transport layer.

Example 9 is the apparatus of Example 1, the logic to receive back pressure information to manage flow control of the display information.

Example 10 is the apparatus of Example 1, the logic to receive the back pressure information from a transport host of a transport layer for communicating with the display sink.

Example 11 is the apparatus of Example 1, the logic to maintain a source common time.

Example 12 is the apparatus of Example 1, the logic to maintain a source common time, the source common time synchronized with a sink common time of the display sink.

Example 13 is the apparatus of Example 1, the logic to provide the display data for every frame at a rate equal to or greater than a refresh rate associated with the display sink.

Example 14 is the apparatus of Example 1, the logic to provide the display data for every frame at a rate equal to or greater than a refresh rate associated with the display sink responsive to the display sink having less than a buffer of storage.

Example 15 is the apparatus of Example 1, the logic to provide the display information responsive to an update to a frame.

Example 16 is the apparatus of Example 1, the logic to provide the display information to update only portions of a frame that have changed.

Example 17 is the apparatus of Example 1, the logic to provide the display information to update only rectangular sections of a frame that have changed.

Example 18 is the apparatus of Example 1, the logic to provide a frame-start control packet comprising frame presentation information to indicate to the display sink a time to present the at least one frame.

Example 19 is the apparatus of Example 1, the logic to provide a frame-start control packet with each new frame.

Example 20 is the apparatus of Example 1, the logic to provide a frame-start control packet comprising frame presentation information, the presentation information comprising an absolute time for presentation of the at least one frame.

Example 21 is the apparatus of Example 1, the logic to provide a frame-start control packet comprising frame presentation information, the presentation information comprising a relative time delay for presentation of the at least one frame relative to a previously presented frame.

Example 22 is the apparatus of Example 1, the display sink information comprising credit management information for a credit management process.

Example 23 is a system comprising the apparatus according to any of Examples 1-22, and at least one processor circuit.

Example 24 is the system of Example 23, comprising at least one transceiver operably connected to the at least one processor circuit.

Example 25 is a method for a display source to provide display information to a display sink, the method comprising generating the display information comprising at least one frame for presentation at a display panel operably coupled to the display sink, receiving display sink information indicating a space availability of a buffer of the display sink, the buffer to store at least a portion of the display information, and providing the display information to the display sink based on the display sink information.

Example 26 is the method of Example 25, comprising transmitting the display information to the display sink via the at least one transceiver.

Example 27 is the method of Example 25, comprising providing the display information to a plurality of display sinks.

Example 28 is the method of Example 25, the display information comprising at least one packet, the at least one packet comprising data corresponding to a block of pixels for the at least one frame.

Example 29 is the method of Example 25, the at least one packet comprising an identifier indicating a frame number a pixel block of the at least one packet belongs to.

Example 30 is the method of Example 25, comprising providing the display information via a transport layer.

Example 31 is the method of Example 25, comprising receiving back pressure information to manage flow control of the display information.

Example 32 is the method of Example 25, comprising receiving the back pressure information from a transport host of a transport layer for communicating with the display sink.

Example 33 is the method of Example 25, comprising maintaining a source common time.

Example 34 is the method of Example 25, comprising maintaining a source common time, the source common time synchronized with a sink common time of the display sink.

Example 35 is the method of Example 25, comprising providing display data for every frame at a rate equal to or greater than a refresh rate associated with the display sink.

Example 36 is the method of Example 25, comprising providing the display information for every frame at a rate equal to or greater than a refresh rate associated with the display sink responsive to the display sink having less than a buffer of storage.

Example 37 is the method of Example 25, comprising providing the display information responsive to an update to a frame.

Example 38 is the method of Example 25, comprising providing the display information to update only portions of a frame that have changed.

Example 39 is the method of Example 25, comprising providing the display information to update only rectangular sections of a frame that have changed.

Example 40 is the method of Example 25, comprising providing a frame-start control packet comprising frame presentation information to indicate to the display sink a time to present the at least one frame.

Example 41 is the method of Example 25, comprising providing a frame-start control packet with each new frame.

Example 42 is the method of Example 25, comprising providing a frame-start control packet comprising frame presentation information, the presentation information comprising an absolute time for presentation of the at least one frame.

Example 43 is the method of Example 25, comprising providing a frame-start control packet comprising frame presentation information, the presentation information comprising a relative time delay for presentation of the at least one frame relative to a previously presented frame.

Example 44 is the method of Example 25, the display sink information comprising credit management information for a credit management process.

Example 45 is a computer-readable storage medium that stores instructions for execution by processing circuitry of a display source, the instructions to cause a computing device to generate the display information comprising at least one frame for presentation at a display panel operably coupled to the display sink, receive display sink information indicating a space availability of a buffer of the display sink, the buffer to store at least a portion of the display information, and provide the display information to the display sink based on the display sink information.

Example 46 is the computer-readable storage medium of Example 45, the instructions to cause the computing device to transmit the display information to the display sink via the at least one transceiver.

Example 47 is the computer-readable storage medium of Example 45, the instructions to cause the computing device to provide the display information to a plurality of display sinks.

Example 48 is the computer-readable storage medium of Example 45, the display information comprising at least one packet, the at least one packet comprising data corresponding to a block of pixels for the at least one frame.

Example 49 is the computer-readable storage medium of Example 45, the at least one packet comprising an identifier indicating a frame number a pixel block of the at least one packet belongs to.

Example 50 is the computer-readable storage medium of Example 45, the instructions to cause the computing device to provide the display information via a transport layer.

Example 51 is the computer-readable storage medium of Example 45, the instructions to cause the computing device to receive back pressure information to manage flow control of the display information.

Example 52 is the computer-readable storage medium of Example 45, the instructions to cause the computing device to receive the back pressure information from a transport host of a transport layer for communicating with the display sink.

Example 53 is the computer-readable storage medium of Example 45, the instructions to cause the computing device to maintain a source common time.

Example 54 is the computer-readable storage medium of Example 45, the instructions to cause the computing device to maintain a source common time, the source common time synchronized with a sink common time of the display sink.

Example 55 is the computer-readable storage medium of Example 45, the instructions to cause the computing device to provide display data for every frame at a rate equal to or greater than a refresh rate associated with the display sink.

Example 56 is the computer-readable storage medium of Example 45, the instructions to cause the computing device to provide the display information for every frame at a rate equal to or greater than a refresh rate associated with the display sink responsive to the display sink having less than a buffer of storage.

Example 57 is the computer-readable storage medium of Example 45, the instructions to cause the computing device to provide the display information responsive to an update to a frame.

Example 58 is the computer-readable storage medium of Example 45, the instructions to cause the computing device to provide the display information to update only portions of a frame that have changed.

Example 59 is the computer-readable storage medium of Example 45, the instructions to cause the computing device to provide the display information to update only rectangular sections of a frame that have changed.

Example 60 is the computer-readable storage medium of Example 45, the instructions to cause the computing device to provide a frame-start control packet comprising frame presentation information to indicate to the display sink a time to present the at least one frame.

Example 61 is the computer-readable storage medium of Example 45, the instructions to cause the computing device to provide a frame-start control packet with each new frame.

Example 62 is the computer-readable storage medium of Example 45, the instructions to cause the computing device to provide a frame-start control packet comprising frame presentation information, the presentation information comprising an absolute time for presentation of the at least one frame.

Example 63 is the computer-readable storage medium of Example 45, the instructions to cause the computing device to provide a frame-start control packet comprising frame presentation information, the presentation information comprising a relative time delay for presentation of the at least one frame relative to a previously presented frame.

Example 64 is the computer-readable storage medium of Example 45, the display sink information comprising credit management information for a credit management process.

Example 65 is an apparatus comprising a display information means to generate display information comprising at least one frame for presentation at a display panel operably coupled to a display sink, a display sink information means to display sink information indicating a space availability of a buffer of the display sink, the buffer to store at least a portion of the display information, and an information transmission means to provide the display information to the display sink based on the display sink information.

Example 66 is the apparatus of Example 65, the information transmission means comprising at least on transceiver.

Example 67 is the apparatus of Example 65, the information transmission means comprising at least on transceiver to transmit the display information to the display sink.

Example 68 is the apparatus of Example 65, the information transmission means to provide the display information to a plurality of display sinks.

Example 69 is the apparatus of Example 65, the apparatus comprising at least one graphics processing unit.

Example 70 is the apparatus of Example 65, the display information comprising at least one packet, the at least one packet comprising data corresponding to a block of pixels for the at least one frame.

Example 71 is the apparatus of Example 65, the at least one packet comprising an identifier indicating a frame number a pixel block of the at least one packet belongs to.

Example 72 is the apparatus of Example 65, the information transmission means to provide the display information via a transport layer.

Example 73 is the apparatus of Example 65, the display sink information means to receive back pressure information to manage flow control of the display information.

Example 74 is the apparatus of Example 65, the display sink information means to receive the back pressure information from a transport host of a transport layer for communicating with the display sink.

Example 75 is the apparatus of Example 65, comprising a common time means to maintain a source common time.

Example 76 is the apparatus of Example 65, comprising a common time means maintain a source common time, the source common time synchronized with a sink common time of the display sink.

Example 77 is the apparatus of Example 65, the information transmission means to provide the display data for every frame at a rate equal to or greater than a refresh rate associated with the display sink.

Example 78 is the apparatus of Example 65, the information transmission means to provide the display data for every frame at a rate equal to or greater than a refresh rate associated with the display sink responsive to the display sink having less than a buffer of storage.

Example 79 is the apparatus of Example 65, the information transmission means to provide the display information responsive to an update to a frame.

Example 80 is the apparatus of Example 65, the information transmission means to provide the display information to update only portions of a frame that have changed.

Example 81 is the apparatus of Example 65, the information transmission means to provide the display information to update only rectangular sections of a frame that have changed.

Example 82 is the apparatus of Example 65, the information transmission means to provide a frame-start control packet comprising frame presentation information to indicate to the display sink a time to present the at least one frame.

Example 83 is the apparatus of Example 65, the information transmission means to provide a frame-start control packet with each new frame.

Example 84 is the apparatus of Example 65, the information transmission means to provide a frame-start control packet comprising frame presentation information, the presentation information comprising an absolute time for presentation of the at least one frame.

Example 85 is the apparatus of Example 65, the information transmission means to provide a frame-start control packet comprising frame presentation information, the presentation information comprising a relative time delay for presentation of the at least one frame relative to a previously presented frame.

Example 86 is the apparatus of Example 65, the display sink information comprising credit management information for a credit management process.

Example 87 is an apparatus comprising at least one memory and logic for a display sink, at least a portion of the logic comprised in hardware coupled to the at least one memory, the logic to determine display sink information indicating a space availability of at least one buffer, provide the display sink information to a display source, receive display information from the display source, and store the display information in the at least one buffer.

Example 88 is the apparatus of Example 87, the logic to provide at least one size of the at least one buffer to the display source.

Example 89 is the apparatus of Example 87, the logic to provide at least one size of the at least one buffer to the display source during an initialization process with the display source.

Example 90 is the apparatus of Example 87, the at least one buffer comprising a sink data buffer.

Example 91 is the apparatus of Example 87, the at least one buffer comprising an assembly frame buffer.

Example 92 is the apparatus of Example 87, the at least one buffer comprising an assembly frame buffer, the logic to generate a frame using the display information of the assembly frame buffer.

Example 93 is the apparatus of Example 87, the at least one buffer comprising a display frame buffer.

Example 94 is the apparatus of Example 87, the logic to display a frame generated using display information in a display frame buffer.

Example 95 is the apparatus of Example 87, the at least one buffer comprising a sink data buffer, an assembly frame buffer, and a display frame buffer.

Example 96 is the apparatus of Example 87, the logic to read unchanged portions of a frame from a display frame buffer into an assembly frame buffer.

Example 97 is the apparatus of Example 87, comprising a display panel, the logic to generate a frame for display at the display panel based on the display information.

Example 98 is a method for managing display information at a display sink, the method comprising determining display sink information indicating a space availability of at least one buffer, providing the display sink information to a display source, receiving display information from the display source, and storing the display information in the at least one buffer.

Example 99 is the method of Example 98, comprising providing at least one size of the at least one buffer to the display source.

Example 100 is the method of Example 98, comprising providing at least one size of the at least one buffer to the display source during an initialization process with the display source.

Example 101 is the method of Example 98, the at least one buffer comprising a sink data buffer.

Example 102 is the method of Example 98, the at least one buffer comprising an assembly frame buffer.

Example 103 is the method of Example 98, comprising generating a frame using the display information of an assembly frame buffer.

Example 104 is the method of Example 98, the at least one buffer comprising a display frame buffer.

Example 105 is the method of Example 98, the logic to display a frame generated using display information in a display frame buffer.

Example 106 is the method of Example 98, the at least one buffer comprising a sink data buffer, an assembly frame buffer, and a display frame buffer.

Example 107 is the method of Example 98, comprising reading unchanged portions of a frame from a display frame buffer into an assembly frame buffer.

Example 108 is the method of Example 98, comprising generating a frame for display at a display panel operably coupled to the display sink based on the display information.

Example 109 is a computer-readable storage medium that stores instructions for execution by processing circuitry of a display sink, the instructions to cause a computing device to determine display sink information indicating a space availability of at least one buffer, provide the display sink information to a display source, receive display information from the display source, and store the display information in the at least one buffer.

Example 110 is the computer-readable storage medium of Example 109, the instructions to cause the computing device to provide at least one size of the at least one buffer to the display source.

Example 111 is the computer-readable storage medium of Example 109, the instructions to cause the computing device to provide at least one size of the at least one buffer to the display source during an initialization process with the display source.

Example 112 is the computer-readable storage medium of Example 109, the at least one buffer comprising a sink data buffer.

Example 113 is the computer-readable storage medium of Example 109, the at least one buffer comprising an assembly frame buffer.

Example 114 is the computer-readable storage medium of Example 109, the instructions to cause the computing device to generate a frame using the display information of an assembly frame buffer.

Example 115 is the computer-readable storage medium of Example 109, the at least one buffer comprising a display frame buffer.

Example 116 is the computer-readable storage medium of Example 109, the instructions to cause the computing device to display a frame generated using display information in a display frame buffer.

Example 117 is the method of Example 98, the at least one buffer comprising a sink data buffer, an assembly frame buffer, and a display frame buffer.

Example 118 is the computer-readable storage medium of Example 109, the instructions to cause the computing device to read unchanged portions of a frame from a display frame buffer into an assembly frame buffer.

Example 119 is the computer-readable storage medium of Example 109, the instructions to cause the computing device to generate a frame for display at a display panel operably coupled to the display sink based on the display information.

Example 120 is an apparatus comprising a display sink information means to: determine display sink information indicating a space availability of at least one buffer, and provide the display sink information to a display source; and a display information means to: receive display information from the display source, and store the display information in the at least one buffer.

Example 121 is the apparatus of Example 120, the display sink information means to provide at least one size of the at least one buffer to the display source.

Example 122 is the apparatus of Example 120, the display sink information means to provide at least one size of the at least one buffer to the display source during an initialization process with the display source.

Example 123 is the apparatus of Example 120, the at least one buffer comprising a sink data buffer.

Example 124 is the apparatus of Example 120, the at least one buffer comprising an assembly frame buffer.

Example 125 is the apparatus of Example 120, comprising a frame presentation means to generate a frame using the display information of the assembly frame buffer.

Example 126 is the apparatus of Example 120, the at least one buffer comprising a display frame buffer.

Example 127 is the apparatus of Example 120, comprising a frame presentation means to display a frame generated using display information in a display frame buffer.

Example 128 is the apparatus of Example 120, the at least one buffer comprising a sink data buffer, an assembly frame buffer, and a display frame buffer.

Example 129 is the apparatus of Example 120, comprising a frame presentation means to read unchanged portions of a frame from a display frame buffer into an assembly frame buffer.

Example 130 is the apparatus of Example 120, comprising a frame presentation means to generate a frame for display at a display panel based on the display information.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
at least one memory; and
logic for a display source, at least a portion of the logic comprised in hardware coupled to the at least one memory, the logic to:
generate display information comprising at least one frame for presentation at a display panel operably coupled to a display sink,
receive display sink information indicating a space availability of a buffer of the display sink, the buffer to store at least a portion of the display information, and
provide the display information to the display sink based on the display sink information.

2. The apparatus of claim 1, the display information comprising at least one packet, the at least one packet comprising data corresponding to a block of pixels for the at least one frame.

3. The apparatus of claim 1, the logic to receive back pressure information to manage flow control of the display information.

4. The apparatus of claim 1, the logic to maintain a source common time, the source common time synchronized with a sink common time of the display sink.

5. The apparatus of claim 1, the logic to provide the display information to update only portions of a frame that have changed.

6. The apparatus of claim 1, the logic to provide a frame-start control packet comprising frame presentation information to indicate to the display sink a time to present the at least one frame.

7. The apparatus of claim 1, the logic to provide a frame-start control packet with each new frame.

8. The apparatus of claim 1, the logic to provide a frame-start control packet comprising frame presentation information, the presentation information comprising an absolute time for presentation of the at least one frame.

9. The apparatus of claim 1, the logic to provide a frame-start control packet comprising frame presentation information, the presentation information comprising a relative time delay for presentation of the at least one frame relative to a previously presented frame.

10. A method for a display source to provide display information to a display sink, the method comprising:
generating the display information comprising at least one frame for presentation at a display panel operably coupled to the display sink;
receiving display sink information indicating a space availability of a buffer of the display sink, the buffer to store at least a portion of the display information; and
providing the display information to the display sink based on the display sink information.

11. The method of claim 10, the display information comprising at least one packet, the at least one packet comprising data corresponding to a block of pixels for the at least one frame.

12. The method of claim 10, comprising receiving back pressure information to manage flow control of the display information.

13. The method of claim 10, comprising maintaining a source common time, the source common time synchronized with a sink common time of the display sink.

14. The method of claim 10, comprising providing the display information to update only portions of a frame that have changed.

15. The method of claim 10, comprising providing a frame-start control packet comprising frame presentation information to indicate to the display sink a time to present the at least one frame.

16. The method of claim 10, comprising providing a frame-start control packet with each new frame.

17. The method of claim 10, comprising providing a frame-start control packet comprising frame presentation information, the presentation information comprising an absolute time for presentation of the at least one frame.

18. The method of claim 10, comprising providing a frame-start control packet comprising frame presentation information, the presentation information comprising a relative time delay for presentation of the at least one frame relative to a previously presented frame.

19. An apparatus, comprising:
at least one memory; and
logic for a display sink, at least a portion of the logic comprised in hardware coupled to the at least one memory, the logic to:
determine display sink information indicating a space availability of at least one buffer,
provide the display sink information to a display source,
receive display information from the display source, and
store the display information in the at least one buffer.

20. The apparatus of claim 19, the logic to provide at least one size of the at least one buffer to the display source.

21. The apparatus of claim 19, the at least one buffer comprising an assembly frame buffer,
the logic to generate a frame using the display information of the assembly frame buffer.

22. The apparatus of claim 19, the logic to display a frame generated using display information in a display frame buffer.

23. The apparatus of claim 19, the at least one buffer comprising a sink data buffer, an assembly frame buffer, and a display frame buffer.

24. The apparatus of claim 19, the logic to read unchanged portions of a frame from a display frame buffer into an assembly frame buffer.

25. The apparatus of claim 19, comprising a display panel,
the logic to generate a frame for display at the display panel based on the display information.
